(19) United States
(12) Patent Application Publication
(10) Pub. No.: US 2021/0125111 A1
(43) Pub. Date: Apr. 29, 2021

(54) Hospitality Services Processing System

(71) Applicant: Andrea Simon, Florence, AZ (US)

(72) Inventor: Andrea Simon, Florence, AZ (US)

(21) Appl. No.: 16/996,556

(22) Filed: Aug. 18, 2020

Related U.S. Application Data
(60) Provisional application No. 62/925,712, filed on Oct. 24, 2019.

(51) Int. Cl. G06Q 10/02; G06Q 20/40; G06Q 20/18; G06Q 20/20; G06Q 50/12

(52) U.S. Cl. CPC G06Q 10/02; G06Q 20/40145; G06Q 50/12; G06Q 20/209; G06Q 20/18

(57) ABSTRACT

Systems and methods for automated hospitality services in a lodging facility. A hospitality services processing system comprises a kiosk and a hospitality services management system. The hospitality management system interacts with an automated kiosk terminal in a hotel via a network to allow a user to complete a variety of hospitality services such as a check in or out process without the need for assistance by hotel staff. The kiosk captures biometric or identification credential information to confirm an existing reservation from a hotel reservation database. The system is configured to accept and process payment and provide hotel room key cards. A method of using the system and kiosk is also provided.

### CROSS-REFERENCE TO RELATED APPLICATION

The present application claims priority to, and the benefit of, U.S. Provisional Application No. 62/925,712, which was filed on Oct. 24, 2019 and is incorporated herein by reference in its entirety.

### BACKGROUND

The present invention generally relates to an automated kiosk, and more specifically to an automated self-service check-in and check-out system for use in the hospitality industry. Accordingly, the present specification makes specific reference thereto. However, it is to be appreciated that aspects of the present invention are also equally amenable to other like applications, devices and methods of manufacture.

Travel logistics for vacationers and business travelers alike can be time consuming, difficult, and frustrating. People try to save as much time as possible by preplanning, pre-booking, and reserving whatever they can prior to arrival to save time on their vacation or business trip. Travel is tiring, so any time saving option generally leads to a better overall travel experience. Automated systems are frequently used for many day to day interactions but are especially valuable during travel. ATM's, on-line airline flight check-in, on-line car rental, on-line train tickets, and travel apps have become mainstream travel tools. Travelers are always looking for the more convenient time saving options.

Checking-in and checking-out of a hotel, motel, vacation property, resort, or the like can be incredibly frustrating and inconvenient. People often have to wait in long lines for a considerable period of time before reaching a clerk at the hotel check-in desk. This problem is compounded further during busy times, during peak seasons, and during staff shortages. Hiring additional staff just to meet demand for these times is often impractical and can lead to expensive and inefficient operations for a hotel. Regardless of the reason, guests that are inconvenienced are much less likely to return to the same property and are likely to leave bad reviews on-line hurting the hotel's business further.

People are always looking for ways to save time and improve convenience while traveling. They often make on-line reservations including payment when booking a hotel or vacation property to speed up the check-in process once they arrive on site. Unfortunately, they still need to physically check in with a hotel clerk once on site to finalize and confirm payment, receive room keys, confirm identity, and the like. Human interaction using hotel staff is expensive and difficult to properly apportion to peak times. The ability to divert the hotel staff to more human interaction required issues will lead to a better overall customer experience saving time and money for the hotel.

Additionally, human employees are prone to making errors. Receptionists and clerks often misspell names, inadvertently book a wrong room, or make other similar manual data entry errors. A self-service option for a customer or guest where they could accurately and quickly download existing data from credit cards, identification credentials, biometrics, and the like would prevent many of these errors leading to a better overall customer experience. Further, as the customer is responsible for entering and confirming the data directly, there is a much lower likelihood of error.

Likewise, hotel guests are looking to save time when checking-out of the hotel. Standing in a line just to turn in keys and get a printout of the bill can be extremely frustrating. Hotels often slide printout of charges under the door on the morning of departure or email the bill if they have an email address for the guest. There are also options to leave your room key card in the room, which is not secure, or put it in a box in the lobby. A single step system to securely, accurately, and safely complete the check-out procedure would similarly improve customer experiences.

In this manner, the improved kiosk system of the present invention accomplishes all of the forgoing objectives, thereby providing an easy solution for speeding up the check-in and check-out processes for guests entering and exiting a hotel. The improved kiosk system also saves expensive employment issues by freeing hotel staff to attend to other hospitality related services for hotel guests that benefit or require personal interaction and attention. The system provides an automated option that can identify guests, process payments, and complete the check-in and check-out processes without the need for hotel staff intervention.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a hospitality services processing system for a lodging facility. The hospitality services processing system comprises a kiosk terminal and a hospitality services management system. The kiosk terminal is configured to allow a user to access lodging facility hospitality services. The kiosk terminal is configured to capture biometric and personally identifying information from an identification credential, accept payment information, and provide a room key card.

The hospitality services management system is configured to accept inputs from the kiosk terminal including captured biometric data and personally identifying information from the identification credential via a network. The hospitality services management system then compares the captured biometric data and the personal identifying information to a database comprising existing reservations and confirms an existing reservation. Next, the hospitality services management system accepts and processes payment and allows the user to complete a hospitality service, such as a check-in or a check-out process.

The kiosk terminal comprises an interactive display screen, at least one biometric capture component, and an identification credential capture component. The interactive display screen allows the user to access the lodging facility hospitality services. The lodging facility hospitality services comprise a check-in process, a check-out process, and additional hospitality services. The at least one biometric capture device may be a camera with facial recognition or a fingerprint scanner, or both. The identification credential capture component comprises a reader configured to capture data from an identification credential.

The kiosk terminal further comprises a payment processing component and a key card dispensing component. The payment processing component collects and accepts payment or payment information. The key card dispensing component encodes or prints a room key card and dispenses it to the user. The kiosk terminal may further comprise a printer for printing a receipt of a transaction. The kiosk terminal may further comprise a room key card disposal component for collecting and securing the used room key cards.

In an additional embodiment, a method for automated access to hospitality services in a temporary lodging comprises using a kiosk terminal to access an existing reservation from a database. The kiosk terminal then captures personally identification information from a user biometrically or from an identification credential. A hospitality services management system compares the captured personally identifying information of the user from the kiosk terminal to the existing reservation in the database and confirms the existing reservation based on the captured personally identifying information. Once confirmed, the user is permitted to complete a check-in process by providing payment and having the kiosk terminal dispense a room key card. The method further comprises allowing a user to complete a check-out process.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of one embodiment of a hospitality services processing system for a lodging facility of the present invention in accordance with the disclosed architecture.

FIG. 2 illustrates a perspective view of a kiosk terminal for assisting a guest with a hospitality service for a lodging facility of the present invention in accordance with the disclosed architecture.

FIG. 3 illustrates a flowchart of computer implemented method for automated access to hospitality services in a temporary lodging the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is an automated hospitality services processing system. The system features a kiosk housing a facial recognition component and fingerprint scanner which work in conjunction to validate a user's identity before delivering hotel room cards and receiving payment information. The kiosk further includes a printing dispenser for distributing one or more hotel key cards for the customer. The system allows users to check in and out of the hotel without other staff intervention, saving time and effort for both guests and hotel employees.

The system comprises a computer, a camera, a payment processor, a fingerprint scanner, and a card printer all housed within an external main body housing. The camera and fingerprint scanner work in conjunction to identify the guest via a fingerprint or facial recognition. The payment processor allows payment for the room to be made while recording personal information from an identification credential of the guest. The card printer may print and dispense one or more hotel room cards for the guest thus allowing users to quickly check in and out of the hotel. Replacement room cards may be distributed in a similar manner and all such cards may be returned via a slot in the external main body housing. The system improves the check in and out process for the guest without the need to interact with the front desk staff.

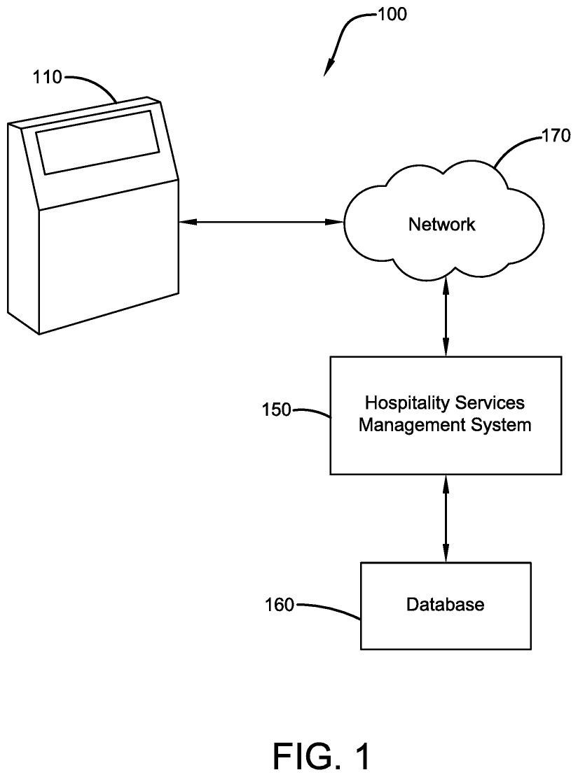

Referring initially to the drawings, FIG. 1 illustrates a diagrammatical illustration of a hospitality services processing system 100 for use in a lodging facility. The hospitality services processing system 100 may be used at any kind of temporary lodging facility, such as, but not limited to, a hotel, a motel, an inn, a bed and breakfast, a resort, or any similar housing configured to accommodate overnight guests on a temporary basis. The hospitality services processing system 100 allows for automated guest check-in, check-out, and other hospitality service requests, such as, but not limited to, making a restaurant reservation, requesting transportation, requesting room service, requesting a wake-up call, or requesting another guest service.

The hospitality services processing system 100 comprises a kiosk terminal 110. The kiosk terminal 110 is configured to allow a user to access lodging facility hospitality services directly from the kiosk terminal 110 without the need for employee assistance from the lodging facility. The kiosk terminal 110 is configured to capture biometric and personally identifying information from an identification credential, accept payment information, and provide a room key card once a check-in process is complete. The kiosk terminal 110 may also be configured to provide interaction in a plurality of different languages.

The hospitality services processing system 100 further comprises a hospitality services management system 150. The hospitality services management system 150 comprises a non-transitory computer-readable medium comprising a set of software instructions configured to accept inputs from the kiosk terminal 110 including captured biometric data and personally identifying information from the identification credential via a network 170. The network 170 connects the kiosk terminal 110 to the hospitality services management system 150. The network 170 may be any of a number of private or public communications mechanisms such as the Internet, a local intranet, a Personal Area Network, a Local Area Network, a Wide Area Network, a Virtual Private Network, or the like. When the kiosk terminal 110 is connected to the hospitality services management system 150 via the network 170, the set of executable software instructions allows the hospitality services management system 150 to perform the functions and methods of the present invention. The hospitality services management system 150 then compares the captured biometric data and the personal identifying information to a database 160 comprising existing reservations and confirms an existing reservation of the user. The captured biometric data may comprise a fingerprint, an image of the user's face, a retinal scan, or the like.

Next, the hospitality services management system 150 is further configured to accept and process a payment input via the kiosk terminal 110. The hospitality services management system 150 is further configured to instruct the kiosk terminal 110 to encode or print and dispense at least one room key card and allow the user to complete an automated check-in process. The hospitality services management system 150 is further configured to complete payment, accept a returned room key card, and allow the user to complete an automated check-out process. Additionally, the hospitality services management system 150 may be further configured to allow the user to complete an additional hospitality service. The additional hospitality service may comprise making a restaurant reservation, amending an existing reservation, requesting transportation, requesting room service, requesting a wake-up call, dispensing additional room key cards, or requesting another guest related service.

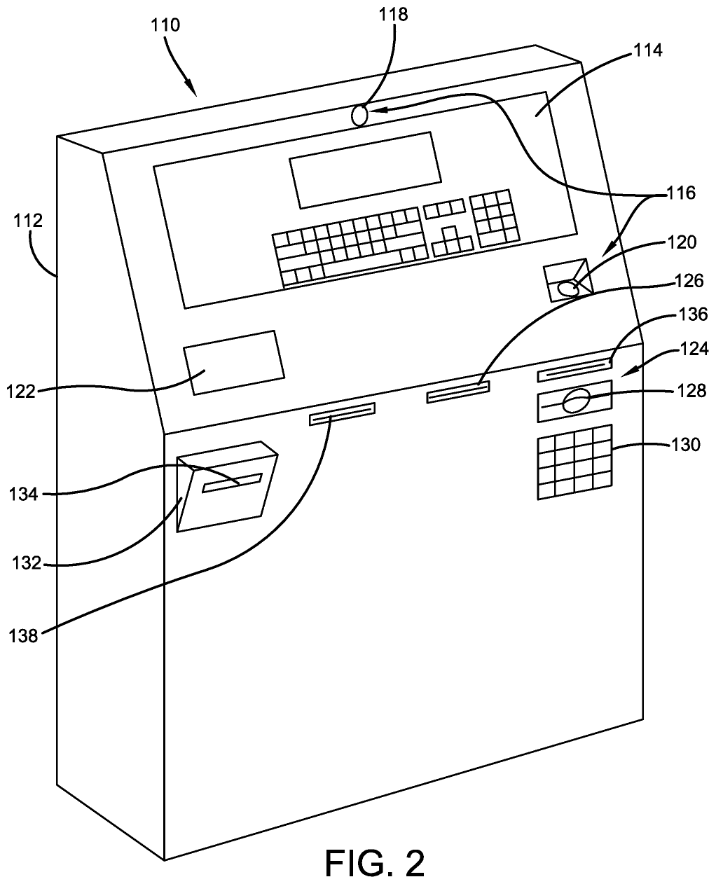

As illustrated in FIG. 2, the kiosk terminal 110 comprises a housing 112 and a display screen 114. The display screen 114 is an interactive display screen that is integrated into the housing 114. The kiosk terminal may be further equipped with a speaker or headphone (not shown) for voice interaction. The kiosk terminal 110 further comprises at least one biometric capture component 116 integrated into the housing 112. The at least one biometric capture component 116 is configured to capture biometric data including a fingerprint, an image of the user's face, or a retinal scan. The at least one biometric capture component 116 may comprise a camera 118 equipped with facial recognition capability or a fingerprint scanner/reader 120. The captured biometric data is then processed by the hospitality services management system 150 to help confirm the existing reservation.

The kiosk terminal 110 further comprises an identification credential capture component 122. The identification credential capture component 122 comprises a reader configured to scan or capture data from an identification credential. The identification credential may be a driver's license, a passport, a government identification card, a military identification card, a hotel rewards card, a state identification card, or other credentialed identification. The captured identification credential data is then processed by the hospitality services management system 150 to help confirm the existing reservation.

Next, the kiosk terminal 110 further comprises a payment processing component 124. The payment processing component 124 accepts payment or payment instructions from the user via a currency acceptor 126, a credit/debit card reader 128 and keypad 130, or an on-line payment process. The payment may be processed immediately by the hospitality services management system 150 or stored in the database 160 until check-out.

The kiosk terminal 110 further comprises a room key card dispensing component 132. The room key card dispensing component 132 is typically a key card encoder or printer 134. The key card encoder or printer 134 electronically or magnetically encodes the room key card as instructed by the hospitality services management system 150. Alternatively, the key card encoder or printer 134 prints the room key card. The room key card is then dispensed to the user via the room key card dispensing component 132. Alternatively, or additionally, the room key card dispensing component 132 may provide a scan code, bar code, Q-code, or the like, that is uploadable to the user's smart phone to be used in place of a physical key card.

The kiosk terminal 110 further comprises a printer 136 and a room key card disposal component 138. As the check-in or check-out is completed, the printer 136 is configured to print a receipt or other directions as instructed by the hospitality services management system 150. Used room key cards may then be placed within the secure room key card disposal component 138 for disposal. The room key card disposal component 138 may be configured to physically destroy or electronically disable the room key cards as desired.

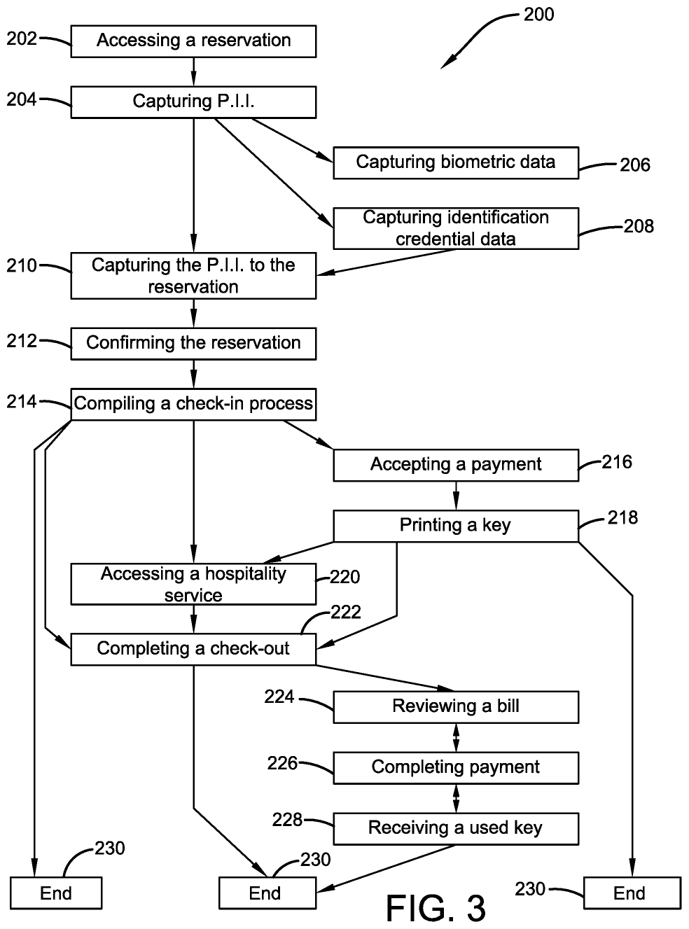

In an additional embodiment as illustrated in FIG. 3, a computer implemented method 200 is provided for automated access to hospitality services in a temporary lodging. The method begins at 202 when a user engages a kiosk terminal 110 located in the temporary lodging to access an existing reservation. At 204, the kiosk terminal 110 uses at least one biometric capture component 116 or an identification credential capture component 122 to capture personally identifying information (P.I.I.). The captured personally identifying information may be biometric information including a fingerprint or an image of the user's face captured at 206 by the at least one biometric capture component 116. The captured personally identifying information may also be identification credential data captured at 208 by the identification credential capture component 122.

At 210, the captured personally identifying information of the user is compared to the existing reservation stored in a database 160 by a hospitality services management system 150 in communication with the kiosk terminal 110 via a network 170. Once the existing reservation is confirmed based on the captured personally identifying information of the user at 212, the user is permitted to complete a check-in process at 214. The check-in process may comprise accepting or holding a payment at 216 and encoding or printing and dispensing a room key card at 218. The method then may end at 230.

Alternatively, the method may continue at 220 where the user may access an additional hospitality service. The additional hospitality service may comprise making a restaurant reservation, amending an existing reservation, requesting transportation, requesting room service, requesting a wake-up call, dispensing additional room key cards, or requesting another guest service. The method may further comprise completing a check-out at 222. At 224, the user may view and review a bill via a display screen 114 of the kiosk terminal 110. At 226, the hospitality services management system 150 may confirm and complete payment entered via a payment processing component 124 of the kiosk terminal 110. And at 228, the user may deposit used room key cards in a room key card disposal component 130 of the kiosk terminal 110 for safe disposal. The method then ends at 230 as before once check-out is complete.

It is contemplated that the hospitality services processing system 100 and method 200 of using the hospitality services processing system 100 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hospitality services processing system for a lodging facility comprising:
a kiosk terminal for allowing a user to access lodging facility hospitality services;
a hospitality services management system configured to:
receive biometric data captured by the kiosk terminal;
receive personal identifying information from an identification credential captured by the kiosk terminal;
compare the captured biometric data and the personal identifying information to a database comprising existing reservations;
confirm an existing reservation of the user; and
allow the user to complete a check-in process.

2. The hospitality services processing system of claim 1, wherein the kiosk terminal comprises at least one biometric capture component and an identification credential capture component.

3. The hospitality services processing system of claim 1, wherein the biometric data captured by the kiosk terminal is a fingerprint or an image of the user's face.

4. The hospitality services processing system of claim 1, wherein the kiosk terminal comprises a key card dispensing component.

5. The hospitality services processing system of claim 1, wherein the hospitality services management system is further configured to process a payment input into the kiosk terminal.

6. The hospitality services processing system of claim 1, wherein the hospitality services management system is further configured to allow the user to complete an additional hospitality service.

7. The hospitality services processing system of claim 1, wherein the hospitality services management system is further configured to complete a check-out process.

8. A kiosk terminal for assisting a guest with a hospitality service for a lodging facility, comprising:
an interactive display screen;
at least one biometric capture component;
an identification credential capture component;
a payment processing component for accepting payment; and
a key card dispensing component for dispensing a room key card.

9. The kiosk terminal of claim 8, wherein the hospitality service is completing an automated hotel check-in process.

10. The kiosk terminal of claim 8, wherein the hospitality service is completing an automated hotel check-out process.

11. The kiosk terminal of claim 8, wherein the least one biometric capture component is a camera equipped with facial recognition.

12. The kiosk terminal of claim 8, wherein least one biometric capture component is a fingerprint scanner.

13. The kiosk terminal of claim 8, wherein the identification credential capture component comprises a reader configured to capture data from a driver's license, a passport, a government identification card, a military identification card, a hotel rewards card, or a state identification card.

14. The kiosk terminal of claim 8, wherein the key card component electronically or magnetically encodes the room key card.

15. The kiosk terminal of claim 8, wherein the key card component prints the room key card.

16. The kiosk terminal of claim 8 further comprising a printer for printing a receipt.

17. A computer implemented method for automated access to hospitality services in a temporary lodging, the method comprising:
using a kiosk terminal to access an existing reservation;
capturing personally identifying information of the user;
comparing the captured personally identifying information of the user to the existing reservation;
confirming the existing reservation based on the captured personally identifying information of the user; and
permitting the user to complete a check-in process.

18. The method of claim 17, wherein completing the check-in process comprises providing payment information and printing at least one hotel key card.

19. The method of claim 17, wherein the captured personally identifying information is a biometric identification or an identification credential.

20. The method of claim 17 further comprising permitting the user to complete a check-out process.
